(19) United States
(12) Patent Application Publication
(10) Pub. No.: US 2018/0374081 A1
(43) Pub. Date: Dec. 27, 2018

(54) PUBLIC TRANSIT PAYMENT METHOD AND DEVICE

(71) Applicant: BEIJING XIAOMI MOBILE SOFTWARE CO., LTD., Beijing (CN)

(72) Inventors: Kai CHEN, Beijing (CN); Along CHAI, Beijing (CN); Chengxin LIU, Beijing (CN)

(73) Assignee: BEIJING XIAOMI MOBILE SOFTWARE CO., LTD., Beijing (CN)

(21) Appl. No.: 16/011,406

(22) Filed: Jun. 18, 2018

(30) Foreign Application Priority Data
Jun. 22, 2017 (CN) 201710482717.8

(51) Int. Cl. G06Q 20/34; G06Q 20/28

(52) U.S. Cl. CPC G06Q 20/351; G06Q 20/354; G06Q 2240/00; G06Q 20/342; G06Q 20/349; G06Q 20/28

(57) ABSTRACT

A public transit payment method and device are provided. The method includes: when it is detected that a balance of a first virtual public transit card associated with a prepaid public transit card is smaller than a first preset balance threshold, a first charging request containing an identifier of the first virtual public transit card is sent to a server, where the prepaid public transit card is associated with at least one virtual public transit card; a charging response for the first virtual public transit card is received; and a public transit payment operation is performed by using the first virtual public transit card.

### CROSS-REFERENCE TO RELATED APPLICATIONS

This application is based upon and claims priority to Chinese Patent Application No. 201710482717.8, filed on Jun. 22, 2017, the entire contents of which are incorporated herein by reference for all purposes.

### TECHNICAL FIELD

The present disclosure generally relates to the technical field of terminal application, and more particularly, to a public transit payment method and device.

### BACKGROUND

Near Field Communication (NFC) modules have gradually become a standard configuration of flagship phones of each mobile phone manufacturer. Providing public transit card service for a user, particularly, a card simulation function of NFC of a mobile phone may become a favorite function for the user. This function may be a field that each domestic and abroad mobile phone manufacturer and even a bank card association rapidly follow and fiercely compete for.

### SUMMARY

The present disclosure discloses a public transit payment method and public transit payment devices.

According to a first aspect of the present disclosure, a public transit payment method is provided. The method may be applied to a terminal and may include: when it is detected that a balance of a first virtual public transit card associated with a prepaid public transit card is smaller than a first preset balance threshold, sending a first charging request containing an identifier of the first virtual public transit card to a server, where the prepaid public transit card is associated with at least one virtual public transit card; receiving a charging response for the first virtual public transit card; and performing a public transit payment operation by using the first virtual public transit card.

According to a second aspect of the present disclosure, a public transit payment device is provided. The public transit payment device may include a processor; and a memory arranged to store instructions executable by the processor, where the processor may be arranged to: when it is detected that a balance of a first virtual public transit card associated with a prepaid public transit card is smaller than a first preset balance threshold, send a first charging request containing an identifier of the first virtual public transit card to a server, where the prepaid public transit card is associated with at least one virtual public transit card; receive a charging response for the first virtual public transit card; and perform a public transit payment operation by using the first virtual public transit card.

According to a third aspect of the present disclosure, a public transit payment device is provided. The public transit payment device may include a processor; and a memory arranged to store instructions executable by the processor, where the processor may be arranged to: when it is determined that a balance of a first virtual public transit card associated with a prepaid public transit card is smaller than a first preset balance threshold, perform a remittance to a bank account associated with transportation card management equipment corresponding to the first virtual public transit card associated with the prepaid public transit card when a balance of the prepaid public transit card is larger than a second preset balance threshold, where the prepaid public transit card is associated with at least one virtual public transit card; and send a second charging request to the transportation card management equipment corresponding to the first virtual public transit card, where the second charging request may include a remittance voucher and an identifier of the first virtual public transit card.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the present disclosure.

FIG. 1 is a diagram of an application scenario of a public transit payment method, according to an example.

FIG. 2 is a flow chart showing a public transit payment method, according to an example.

FIG. 3 is a flow chart showing a public transit payment method, according to an example.

FIG. 4 is a flow chart showing a public transit payment method, according to an example.

FIG. 5 is a block diagram of a public transit payment device, according to an example.

FIG. 6 is a block diagram of a public transit payment device, according to an example.

FIG. 7 is a block diagram of a public transit payment device, according to an example.

FIG. 8 is a block diagram of a public transit payment device, according to an example.

FIG. 9 is a block diagram of a public transit payment device, according to an example.

FIG. 10 is a block diagram of a public transit payment device, according to an example.

FIG. 11 is a block diagram of a public transit payment device, according to an example.

FIG. 12 is a block diagram of a public transit payment device, according to an example.

FIG. 13 is a block diagram of a public transit payment device, according to an example.

FIG. 14 is a block diagram of a public transit payment device, according to an example.

FIG. 15 is a block diagram of a public transit payment device, according to an example.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to examples, examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the present disclosure. Instead, they are merely examples of apparatuses and methods consistent with aspects related to the present disclosure as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” and the like may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Sometimes, a manner for terminals, such as mobile phones, to access public transit card companies usually lies in: connecting transportation card management equipment or all-purpose card management equipment of each city one by one and displaying public transit service of these cities to users through wallet clients in a centralized manner. A user may see public transit card entries of multiple cities on a mobile phone. The user may select his/her own required city for public transit card issuing and charging, and may install a public transit card of this city in the mobile phone of the user, and then the user may use municipal public transit service. In this way, every time when arriving at a new city, the user may be required to install a local public transit card, and can start use after charging the public transit card.

Also, a public transit service capability of each city may be transferred from offline to online for the user to access through the mobile phone; and parts may be gathered into a whole, and dispersion is turned into centralization, so that the user may activated public transit service of multiple cities through a mobile phone client. However, the this implementation may only simply and ponderously replicate an offline public transit payment mode, the user may use the public transit service of each city only by manually charging each virtual public transit card, thus an operating process may be complex and tedious, and a user experience may not be very good.

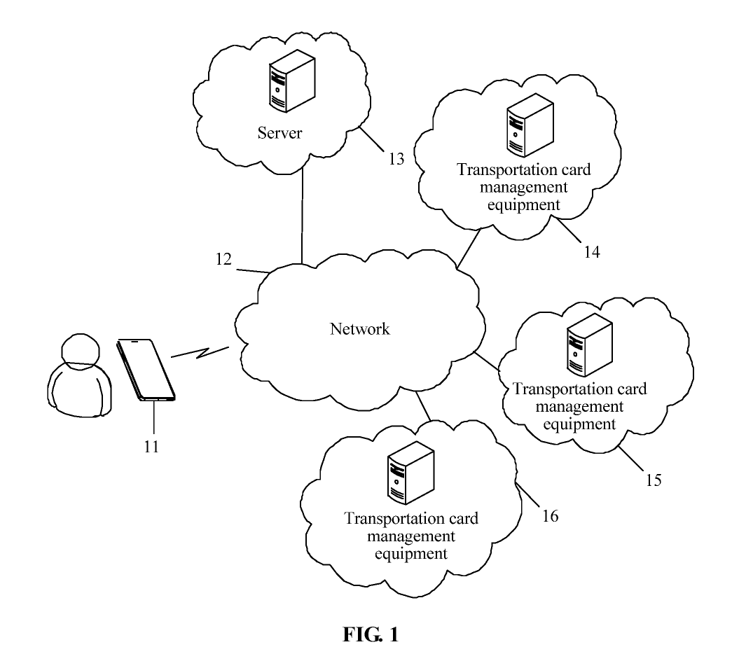

Referring to FIG. 1, an optional application scenario of a public transit payment method in an example of the present disclosure is shown. The application scenario shown in FIG. 1 includes: a terminal 11, a network 12, a server 13, transportation card management equipment 14, transportation card management equipment 15 and transportation card management equipment 15, and the terminal 11, the server 13, the transportation card management equipment 14, the transportation card management equipment 15 and the transportation card management equipment 16 perform communication and data interaction through the network 12; the network 12 is a wired or wireless network; and the transportation card management equipment 14, the transportation card management equipment 15 and the transportation card management equipment 16 are transportation card management equipment corresponding to three different cities respectively.

Sometimes, the server 14 of a public transit payment service performs public transit payment service connection with the transportation card management equipment of each city one by one, the background server 13 displays public transit service of each city to a user in a centralized manner through the terminal 11 or a terminal application (such as a wallet client), a virtual public transit card entry of each city is displayed on a user interface of the terminal 11, every time when arriving at a new city, the user is required to manually select the virtual public transit card entry of this city for a card issuing and charging process of the virtual public transit card, the terminal acquires the virtual public transit card of the city, and then the user may use municipal public transit service in the city. As such, for this implementation, the user may use the public transit service of each city only by manually charging each virtual public transit card, the operating process is complex and tedious, and the user experience is poor.

It is important to note that the application scenario shown in FIG. 1 is only a possible application scenario example of the technical solution provided by the example of the present disclosure, FIG. 1 also exemplarily includes the transportation card management equipment of three cities, and another application scenario may include equipment not involved in FIG. 1 and transportation card management equipment of any number of cities.

The technical solution recorded in the example of the present disclosure may be applied to the above scenario to help to solve the problems of complex and tedious operating process and poor user experience.

In order to solve the problem, an example of the present disclosure provides a public transit payment method, which includes that: when it is detected that a balance of a first virtual public transit card associated with a prepaid public transit card is smaller than a first preset balance threshold, a first charging request containing an identifier of the first virtual public transit card is sent to a server, wherein the prepaid public transit card is associated with at least one virtual public transit card; a charging response for the first virtual public transit card is received; and a public transit payment operation is performed by virtue of the first virtual public transit card.

In the technical solution provided by the example of the present disclosure, when it is detected that the balance of the first virtual public transit card associated with the prepaid public transit card is insufficient, the charging request is automatically sent to the server, the public transit payment operation may be performed by virtue of the first virtual public transit card to automatically initiate a virtual public transit card charging process after the charging response is received, a user is not required to maintain a charging matter of each virtual public transit card, a manual charging operating process of the user is eliminated, and a user experience is improved.

It is important to point out that the terminal in the example of the present disclosure may be user equipment such as an intelligent mobile phone, a tablet computer, a desktop computer, a notebook computer and wearable equipment.

On the basis of the application scenario recorded above, each of the following specific examples is provided.

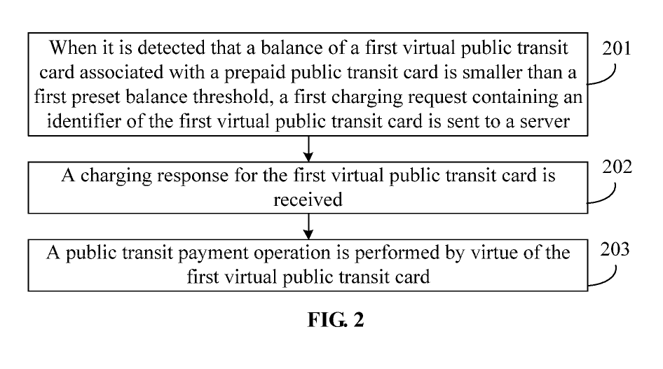

FIG. 2 is a flow chart showing a public transit payment method, according to an example. An execution main body of the method may be a terminal, and as shown in FIG. 2, the method includes the following steps 201-203.

In Step 201, when it is detected that a balance of a first virtual public transit card associated with a prepaid public transit card is smaller than a first preset balance threshold, a first charging request containing an identifier of the first virtual public transit card is sent to a server, wherein the prepaid public transit card is associated with at least one virtual public transit card.

In Step 202, a charging response for the first virtual public transit card is received.

In Step 203, a public transit payment operation is performed by virtue of the first virtual public transit card.

Exemplarily, the prepaid public transit card is associated with at least one virtual public transit card, and the prepaid public transit card is arranged to charge each virtual public transit card. The first preset balance threshold includes: a maximum single public transit consumption value of a target city or a double of the maximum single public transit consumption value of the target city. The first preset balance threshold may be a threshold set by a user/terminal/server and corresponding to a target virtual public transit card, and may also be a threshold set by the user/terminal/server and applied to all virtual public transit cards.

Optionally, a time when the terminal detects whether a balance of the virtual public transit card associated with the prepaid public transit card is smaller than the first preset balance threshold or not may include, but not limited to, any one of the following conditions: 1) when determining that the user is about to use public transit service of a target city, the terminal determines the first virtual public transit card corresponding to the target city, and detects whether the balance of the first virtual public transit card is smaller than the first preset balance threshold or not; 2) the terminal acquires current position information of the terminal when monitoring a selection operation over the prepaid public transit card, and the terminal determines a target virtual public transit card matched with the current position information of the terminal, and detects whether a balance of the target virtual public transit card is smaller than the first preset balance threshold or not; and 3) the terminal acquires a destination or stopover after acquiring a travel itinerary of the user, determines a target virtual public transit card corresponding to the destination or stopover, and detects a balance of the target virtual public transit card is smaller than the first preset balance threshold or not.

Exemplarily, the prepaid public transit card is pre-activated for the user, and the prepaid public transit card is charged. For example, the terminal sends an account opening application to the server, wherein the account opening application is arranged to request the server for activating the prepaid public transit card for the terminal; the server sends an account opening response to the terminal, the account opening response including an identifier of the prepaid public transit card activated by the server for the terminal; and the terminal receives the account opening response returned by the server, and parses the account opening response to obtain the prepaid public transit card. The terminal acquires and stores more than one virtual public transit card, and associates the prepaid public transit card with the virtual public transit card, and the prepaid public transit card may charge all the virtual public transit cards associated with the prepaid public transit card. During a practical application, an implementation manner for the terminal to acquire and store the more than one virtual public transit card may at least include any one or combination of the following manners.

A first manner: the terminal acquires address information of the user, the address information being associated with historical activities or schedule of the user; and the terminal acquires and stores a virtual public transit card associated with the address information on the basis of the address information. For example, the terminal sends a request of acquiring the virtual public transit card to transportation card management equipment corresponding to the address information, the request at least including identification information of the terminal; the transportation card management equipment returns information of the virtual public transit card to the terminal after receiving the request; and the terminal installs the virtual public transit card according to the information of the virtual public transit card.

A second manner: after issuing the prepaid public transit card to the user, the server applies the transportation card management equipment for activation of a virtual public transit card for the user; and the server may only activate a virtual public transit card of a city the user is about to go to or a city the user frequently goes to for the user, and may also activate virtual public transit cards of all cities supported by or connected with the server. For example, the server applies the transportation card management equipment of each city for activation of the virtual public transit card of each city for the user; each piece of transportation card management equipment sends a virtual public transit card activation message to the terminal; and the terminal receives the virtual public transit card activation message sent by the server, the virtual public transit card activation message including an identifier of at least one virtual public transit card applied by the server from the transportation card management equipment to be activated for the prepaid public transit card.

Exemplarily, the terminal is required to determine the virtual public transit card to be used before the public transit payment operation, and a specific manner may include: a manner a, the terminal may acquire a current position and autonomously activate the first virtual public transit card associated with the current position; a manner b, the terminal may pre-judge/pre-determine a place the user is probably about to go according to the historical activities or schedule of the user and acquire the first virtual public transit card corresponding to the place; and a manner c, the user may manually select the first virtual public transit card to be used from multiple virtual public transit cards associated with the prepaid public transit card on the terminal.

Exemplarily, all the virtual public transit cards associated with the prepaid public transit card are displayed on a display interface of the terminal, and the user manually selects the first virtual public transit card to be used from the multiple virtual public transit cards associated with the prepaid public transit card; or, the prepaid public transit card may also be displayed on the display interface of the terminal according to preconfigured information of a unified card face, and the more than one virtual public transit card associated with the prepaid public transit card is locally stored, where the terminal acquires the preconfigured information of the unified card face, the unified card face refers to a pattern, symbol or the like arranged to be displayed as a card face of the virtual public transit card, information of the unified card face is preconfigured and stored in a database, only the prepaid public transit card is displayed on a user interface of the terminal, the virtual public transit cards associated with the prepaid public transit card are not directly displayed on the user interface, the user may not see these virtual public transit cards, and the user only sees the prepaid public transit card.

For example, before the user passes through a gate of public transit service, the prepaid public transit card is called, the terminal makes a judgment/determination through a geographical position of the user, and automatically selects the virtual public transit card corresponding to a current city, at this moment, the prepaid public transit card is mapped onto the practical virtual public transit card, and then the user may perform public transit payment by virtue of the prepaid public transit card and enjoy virtual public transit card-based consumption service.

Exemplarily, for ensuring that the user may smoothly perform public transit payment by virtue of the prepaid public transit card, the terminal may detect the balance of the first virtual public transit card to be used, and when detecting that the balance of the first virtual public transit card is smaller than the first preset balance threshold, the terminal sends the first charging request containing the identifier of the first virtual public transit card to the server; when the server determines that the balance of the first virtual public transit card associated with the prepaid public transit card is smaller than a first preset balance threshold, a remittance to a bank account associated with transportation card management equipment corresponding to the first virtual public transit card is performed on the basis of the prepaid public transit card when a balance of the prepaid public transit card is larger than a second preset balance threshold, where the prepaid public transit card is associated with at least one virtual public transit card, the prepaid public transit card may be associated with multiple virtual public transit card for one or multiple cities. The present disclosure discloses a method to use one pre-paid public transit card to fund multiple virtual public transit cards. The one pre-paid public transit card may send funds to the bank account of one virtual public transit card when the balance of the one virtual public transit card is less than a first preset balance threshold and at the same time the balance of the prepaid public transit card is larger than a second preset balance threshold.

The amount the pre-paid public transit card that may send to the bank account associated with each individual virtual public transit card may vary. For example, the amount may be set according to a historical usage of the user for a virtual public transit card. Alternatively, the user may choose a certain amount to fund an individual virtual public transit card. Additionally, as the price of the public transit for different cities may be different, the amount to be send to each virtual public transit card in different cities may be set according to the different price of the public transit in different cities. The amount should have minimum value which may satisfy at least one maximum single public transit consumption value of the target city for the virtual public transit card.

The server may send a second charging request to the transportation card management equipment corresponding to the first virtual public transit card, the second charging request including a remittance voucher and the identifier of the first virtual public transit card; and the transportation card management equipment sends a charging response to the terminal after receiving the second charging request. Exemplarily, the server may also acquire a balance of each virtual public transit card according to historical charging data of the user, and determines the first virtual public transit card of which the balance is smaller than the first preset balance threshold.

Exemplarily, when the balance of the first virtual public transit card is larger than the first preset balance threshold, for example, the balance of the first virtual public transit card is larger than the maximum single public transit consumption value of the target city, public transit payment of a single travel of the user may be ensured to be smoothly implement. For another example, when the balance of the first virtual public transit card is larger than the double of the maximum single public transit consumption value of the target city, smooth roundtripping of the user may be ensured.

In the technical solution provided by the example of the present disclosure, when it is detected that the balance of the first virtual public transit card associated with the prepaid public transit card is insufficient, the charging request is automatically sent to the server, the public transit payment operation may be performed by using the first virtual public transit card to automatically initiate a virtual public transit card charging process after the charging response is received, the user is not required to maintain a charging process or effort for each individual virtual public transit card, and a manual charging operating process of the user is eliminated, so that a user experience is improved.

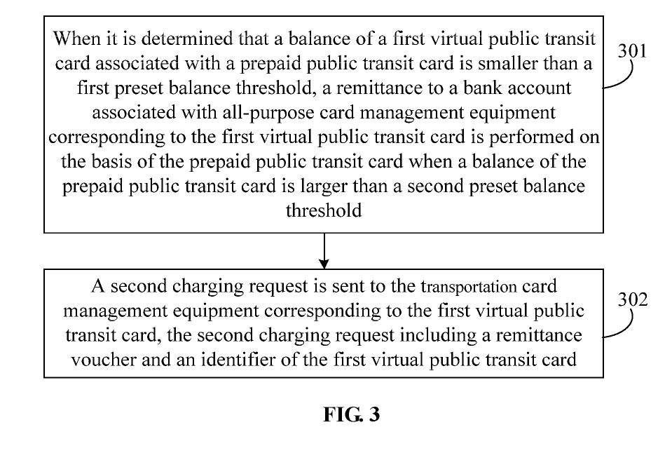

FIG. 3 is a flow chart showing a public transit payment method, according to an example. An execution main body of the method may be a server. As shown in FIG. 3, the method includes the following Steps 301-302.

In Step 301, when it is determined that a balance of a first virtual public transit card associated with a prepaid public transit card is smaller than a first preset balance threshold, a remittance to a bank account associated with transportation card management equipment corresponding to the first virtual public transit card is performed on the basis of the prepaid public transit card when a balance of the prepaid public transit card is larger than a second preset balance threshold, wherein the prepaid public transit card is associated with at least one virtual public transit card.

Exemplarily, the server may determine that the balance of the first virtual public transit card associated with the prepaid public transit card is smaller than the first preset balance threshold in any one of the following manners: 1) when a first charging request containing an identifier of the first virtual public transit card is received from a terminal, it is determined that the balance of the first virtual public transit card associated with the prepaid public transit card is smaller than the first preset balance threshold; and 2) the server acquires a balance of each virtual public transit card according to historical charging data of a user, and determines the first virtual public transit card of which the balance is smaller than the first preset balance threshold.

In Step 302, a second charging request is sent to the transportation card management equipment corresponding to the first virtual public transit card, the second charging request including a remittance voucher and an identifier of the first virtual public transit card.

Exemplarily, the server acquires a latest usage time of each virtual public transit card; a virtual public transit card of which the latest usage time is earlier than a preset time threshold is determined as a second virtual public transit card; and a drawback instruction is sent to transportation card management equipment corresponding to the second virtual public transit card, wherein the drawback instruction is arranged to cause the transportation card management equipment corresponding to the second virtual public transit card to draw a balance of the second virtual public transit card back to the prepaid public transit card. A balance of an idle virtual public transit card is cleared, and the balance is drawn back to the prepaid public transit card of the user, so that idle and waste funds of the user are prevented.

Exemplarily, the above operations of determining the idle virtual public transit card, sending the drawback instruction to the transportation card management equipment corresponding to the idle virtual public transit card and the like may also be executed by the terminal.

In the technical solution provided by the example of the present disclosure, when the server determines that the balance of the first virtual public transit card associated with the prepaid public transit card is smaller than the first preset balance threshold, when it is determined that the balance of the prepaid public transit card is larger than the second preset balance threshold, a remittance to the bank account associated to the transportation card management equipment corresponding to the first virtual public transit card is performed on the basis of the prepaid public transit card, the transportation card management equipment is indicated to charge the first virtual public transit card to implement automatic charging, the user is not required to maintain a charging matter of each virtual public transit card, a manual charging operating process of the user is eliminated, and a user experience may be improved.

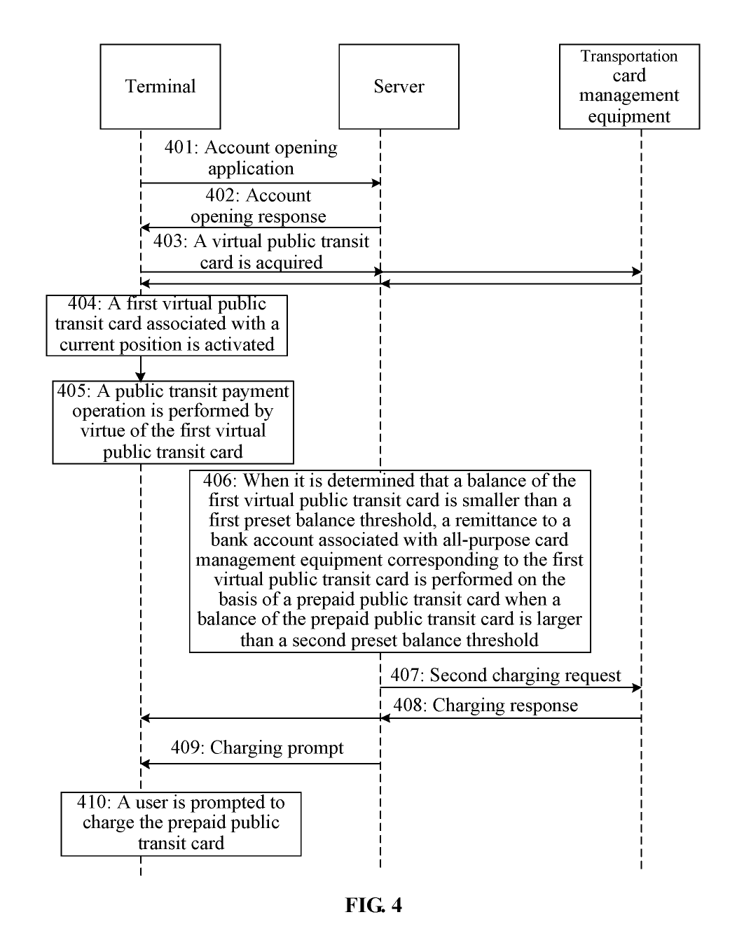

FIG. 4 is a flow chart showing a public transit payment method, according to an example. The method is implemented by cooperation of a terminal, a server and transportation card management equipment, and different virtual public transit cards may correspond to different transportation card management equipment. One piece of transportation card management equipment is exemplarily displayed in FIG. 4. One or more than one piece of transportation card management equipment may practically be included. As shown in FIG. 4, the public transit payment method involved in the present disclosure includes the following steps.

In Step 401, the terminal sends an account opening application to the server, wherein the account opening application is arranged to request the server for activating a prepaid public transit card for the terminal.

In Step 402, the server sends an account opening response to the terminal, the account opening response including an identifier of the prepaid public transit card activated by the server for the terminal, and the terminal receives the account opening response returned by the server, parses the account opening response to obtain the prepaid public transit card, and charges the prepaid public transit card.

In Step 403, the terminal acquires and stores at least one or more virtual public transit cards, and associates the prepaid public transit card with the virtual public transit cards, wherein the prepaid public transit card may charge all the virtual public transit cards associated with the prepaid public transit card. During a practical application, an implementation manner for the terminal to acquire and store the more than one virtual public transit card may include any one or combination of the following manners.

1: the terminal acquires address information of a user, the address information being associated with historical activities or schedule of the user; and the terminal acquires and stores a virtual public transit card associated with the address information on the basis of the address information. For example, the terminal sends a request of acquiring the virtual public transit card to transportation card management equipment corresponding to the address information, the request at least including identification information of the terminal; the transportation card management equipment returns information of the virtual public transit card to the terminal after receiving the request; and the terminal installs the virtual public transit card according to the information of the virtual public transit card.

2: the terminal acquires a virtual public transit card indicated by the user.

3: after issuing the prepaid public transit card to the user, the server applies the transportation card management equipment for activation of a virtual public transit card for the user; and the server may only activate a virtual public transit card of a city the user is about to go to or a city the user frequently goes to for the user, and may also activate virtual public transit cards of all cities supported by or connected with the server. For example, the server applies the transportation card management equipment of each city for activation of the virtual public transit card of each city for the user; each piece of transportation card management equipment sends a virtual public transit card activation message to the terminal; and the terminal receives the virtual public transit card activation message sent by the server, the virtual public transit card activation message including an identifier of at least one virtual public transit card applied by the server from the transportation card management equipment to be activated for the prepaid public transit card.

In Step 404, the terminal activates the first virtual public transit card associated with a current position.

In Step 405, the terminal performs a public transit payment operation by virtue of the first virtual public transit card.

In Step 406, when the server determines that a balance of the first virtual public transit card associated with the prepaid public transit card is smaller than a first preset balance threshold, a remittance to a bank account associated with transportation card management equipment corresponding to the first virtual public transit card is performed on the basis of the prepaid public transit card when a balance of the prepaid public transit card is larger than a second preset balance threshold, wherein the prepaid public transit card is associated with at least one virtual public transit card.

Exemplarily, an implementation manner for the server to determine that the balance of the first virtual public transit card associated with the prepaid public transit card is smaller than the first preset balance threshold may be, for example, as follows: when the terminal detects that the balance of the first virtual public transit card associated with the prepaid public transit card is smaller than a first preset balance threshold, a first charging request containing an identifier of the first virtual public transit card is sent to the server; and when receiving the first charging request containing the identifier of the first virtual public transit card from the terminal, the server determines that the balance of the first virtual public transit card associated with the prepaid public transit card is smaller than the first preset balance threshold. The server may also acquire a balance of each virtual public transit card according to historical charging data of the user and determine the first virtual public transit card of which the balance is smaller than the first preset balance threshold. Practically, with adoption of the solution of the present disclosure, the user is not required to actively pay attention to whether the balance of each virtual public transit card is sufficient or not, and the terminal may automatically charge each virtual public transit card associated with the prepaid public transit card by virtue of the prepaid public transit card, so that influence on normal use of the user is avoided.

In Step 407, the server sends a second charging request to the transportation card management equipment corresponding to the first virtual public transit card, the second charging request including a remittance voucher and an identifier of the first virtual public transit card.

In Step 408, the transportation card management equipment receives the second charging request sent by the server, and when the identifier of the first virtual public transit card and the remittance voucher are acquired, sends a charging response containing the identifier of the first virtual public transit card to the terminal, and the terminal receives the charging response sent by the transportation card management equipment through the server and containing the identifier of the first virtual public transit card, i.e. the charging response for the first virtual public transit card.

In Step 409, when determining that the balance of the prepaid public transit card is smaller than the second preset balance threshold, the server sends a charging prompt to the terminal, wherein the charging prompt is arranged to prompt the user to charge the prepaid public transit card.

Exemplarily, if the user has signed a password-free payment protocol with a bank in advance, the server may automatically initiate withholding of a specified amount and charge the public transit card to be used, that is, a preset charging amount is deducted from a financial account of the user associated with the prepaid public transit card, and the prepaid public transit card is charged by virtue of the preset charging amount.

In Step 410, the terminal receives the charging prompt sent by the server, determines that the balance of the prepaid public transit card is smaller than a second preset balance threshold, and prompts the user to charge the prepaid public transit card.

According to the technical solution provided by the example of the present disclosure, the flow of the public transit payment method implemented by cooperation of the terminal, the server and the transportation card management equipment is described, processes of account opening of the prepaid public transit card, charging of the virtual public transit card, prepaid public transit card-based payment and the like are involved, a virtual public transit card charging process is automatically initiated, the user is not required to maintain a charging matter of each virtual public transit card, and a manual charging operating process of the user is eliminated, so that a user experience may be improved.

The below is the device example of the present disclosure, which may be arranged to execute the method examples of the present disclosure.

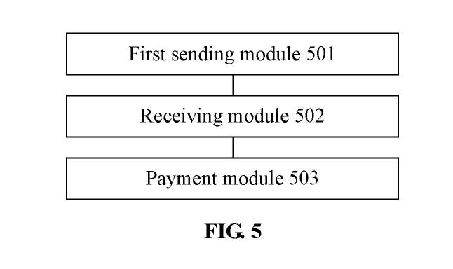

FIG. 5 is a block diagram of a public transit payment device, according to an example. The device may be implemented in various manners. For example, all components of the device are implemented in a terminal, or, the components in the device are implemented on a terminal side in a coupling manner. The device may implement the method involved in the present disclosure through software, hardware or a combination of the two. As shown in FIG. 5, the public transit payment device includes: a first sending module 501, a receiving module 502 and a payment module 503, wherein

the first sending module 501 is arranged to, when it is detected that a balance of a first virtual public transit card associated with a prepaid public transit card is smaller than a first preset balance threshold, send a first charging request containing an identifier of the first virtual public transit card to a server, wherein the prepaid public transit card is associated with at least one virtual public transit card;

the receiving module 502 is arranged to receive a charging response for the first virtual public transit card; and

the payment module 503 is arranged to perform a public transit payment operation by virtue of the first virtual public transit card.

The device provided by the example of the present disclosure may be arranged to execute the technical solution of the example shown in FIG. 2, and a execution manner and beneficial effects thereof are similar, and will not be elaborated herein.

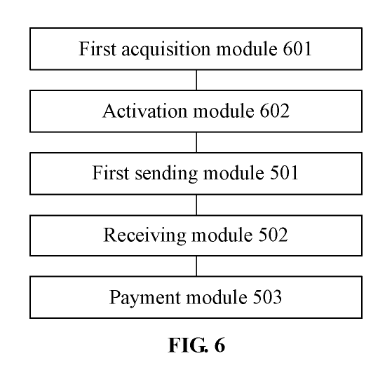

In a possible implementation mode, as shown in FIG. 6, the public transit payment device shown in FIG. 5 may further include: a first acquisition module 601 and an activation module 602, wherein

the first acquisition module 601 is arranged to acquire a current position; and

the activation module 602 is arranged to activate the first virtual public transit card, the first virtual public transit card being associated with the current position.

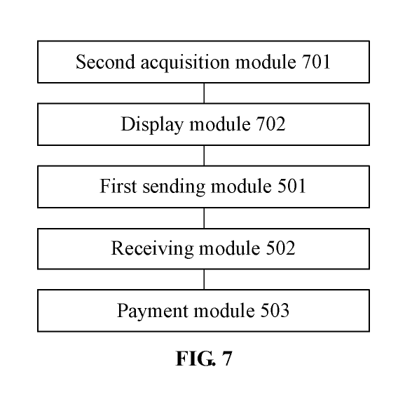

In a possible implementation mode, as shown in FIG. 7, the public transit payment device shown in FIG. 5 may further include: a second acquisition module 701 and a display module 702, wherein

the second acquisition module 701 is arranged to acquire preconfigured information of a unified card face; and

the display module 702 is arranged to display the prepaid public transit card according to the information of the unified card face, wherein more than one virtual public transit card associated with the prepaid public transit card is locally stored.

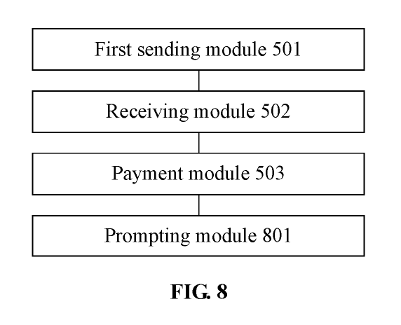

In a possible implementation mode, as shown in FIG. 8, the public transit payment device shown in FIG. 5 may further include: a prompting module 801 arranged to, when it is determined that a balance of the prepaid public transit card is smaller than a second preset balance threshold, prompt a user to charge the prepaid public transit card.

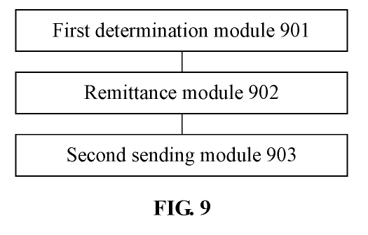

FIG. 9 is a block diagram of a public transit payment device, according to an example. The device may be implemented in various manners. For example, all components of the device are implemented in a terminal, or, the components in the device are implemented on a terminal side in a coupling manner. The device may implement the method involved in the present disclosure through software, hardware or a combination of the two. As shown in FIG. 9, the public transit payment device includes: a first determination module 901, a remittance module 902 and a second sending module 903, wherein

the first determination module 901 is arranged to determine that a balance of a first virtual public transit card associated with a prepaid public transit card is smaller than a first preset balance threshold;

the remittance module 902 is arranged to, when it is determined that the balance of the first virtual public transit card associated with the prepaid public transit card is smaller than the first preset balance threshold, perform a remittance to a bank account associated with transportation card management equipment corresponding to the first virtual public transit card on the basis of the prepaid public transit card when a balance of the prepaid public transit card is larger than a second preset balance threshold, wherein the prepaid public transit card is associated with at least one virtual public transit card; and

the second sending module 903 is arranged to send a second charging request to the transportation card management equipment corresponding to the first virtual public transit card, the second charging request including a remittance voucher and an identifier of the first virtual public transit card.

In a possible implementation mode, the first determination module 901:

determines that the balance of the first virtual public transit card associated with the prepaid public transit card is smaller than the first preset balance threshold when a first charging request containing the identifier of the first virtual public transit card is received from a terminal;

or,

acquires a balance of each virtual public transit card according to historical charging data of a user and determines the first virtual public transit card of which the balance is smaller than the first preset balance threshold.

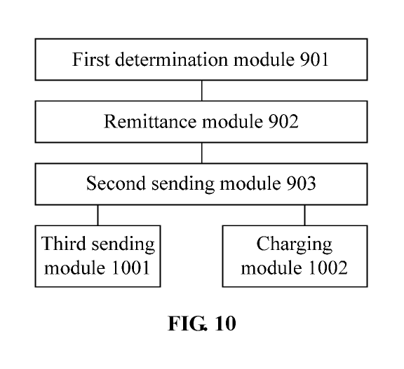

In a possible implementation mode, as shown in FIG. 10, the public transit payment device shown in FIG. 9 may further include:

a third sending module 1001 arranged to, when it is determined that the balance of the prepaid public transit card is smaller than the second preset balance threshold, send a charging prompt to the terminal, wherein the charging prompt is arranged to prompt the user to charge the prepaid public transit card; and

a charging module 1002 arranged to, when it is determined that the balance of the prepaid public transit card is smaller than the second preset balance threshold, deduct a preset charging amount from a financial account of the user associated with the prepaid public transit card, and charge the prepaid public transit card by virtue of the preset charging amount.

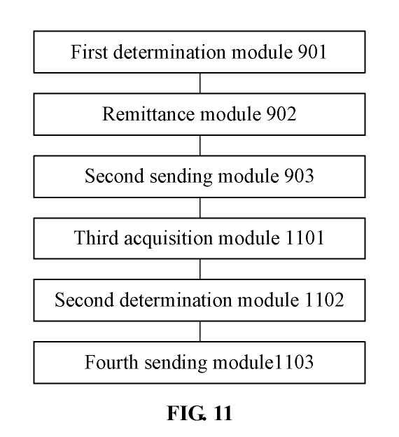

In a possible implementation mode, as shown in FIG. 11, the public transit payment device shown in FIG. 9 may further include: a third acquisition module 1101, a second determination module 1102 and a fourth sending module 1103, wherein

the third acquisition module 1101 is arranged to acquire a latest usage time of each virtual public transit card;

the second determination module 1102 is arranged to determine, as a second virtual public transit card, a virtual public transit card of which the latest usage time is earlier than a preset time threshold; and

the fourth sending module 1103 is arranged to send a drawback instruction to transportation card management equipment corresponding to the second virtual public transit card, wherein the drawback instruction is arranged to cause the transportation card management equipment corresponding to the second virtual public transit card to draw a balance of the second virtual public transit card back to the prepaid public transit card.

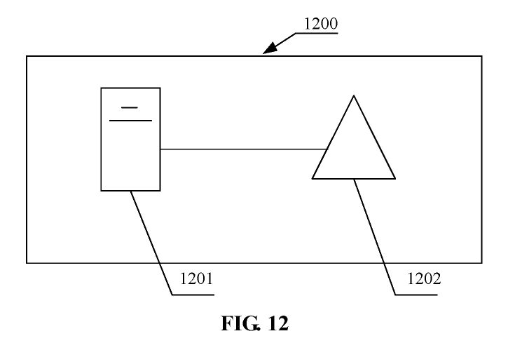

FIG. 12 is a block diagram of a public transit payment device 1200, according to an example. The public transit payment device 1200 may be implemented in various manners. For example, all components of the device are implemented in a terminal, or, the components in the device are implemented on a terminal side in a coupling manner. The public transit payment device 1200 includes:

a processor 1201; and

a memory 1202 arranged to store instructions executable by the processor,

wherein the processor 1201 is arranged to:

when it is detected that a balance of a first virtual public transit card associated with a prepaid public transit card is smaller than a first preset balance threshold, send a first charging request containing an identifier of the first virtual public transit card to a server, wherein the prepaid public transit card is associated with at least one virtual public transit card;

receive a charging response for the first virtual public transit card; and

perform a public transit payment operation by virtue of the first virtual public transit card.

In an example, the first preset balance threshold includes: a maximum single public transit consumption value of a target city or a double of the maximum single public transit consumption value of the target city.

In an example, the processor 1201 may further be arranged to:

acquire a current position; and

activate the first virtual public transit card, the first virtual public transit card being associated with the current position.

In an example, the processor 1201 may further be arranged to:

acquire preconfigured information of a unified card face; and

display the prepaid public transit card according to the information of the unified card face, wherein more than one virtual public transit card associated with the prepaid public transit card is locally stored.

In an example, the processor 1201 may further be arranged to:

when it is determined that a balance of the prepaid public transit card is smaller than a second preset balance threshold, prompt a user to charge the prepaid public transit card.

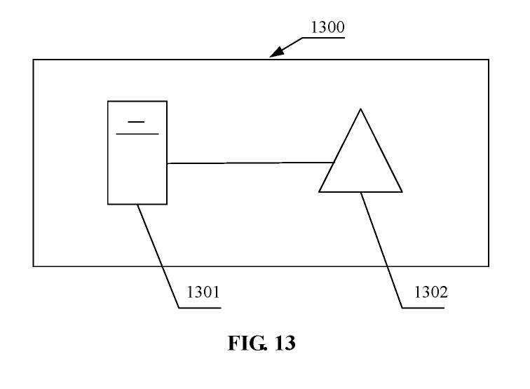

FIG. 13 is a block diagram of a public transit payment device 1300, according to an example. The public transit payment device 1200 may be implemented in various manners. For example, all components of the device are implemented in a terminal, or, the components in the device are implemented on a terminal side in a coupling manner. The public transit payment device 1200 includes:

a processor 1301; and

a memory 1302 arranged to store instructions executable by the processor,

wherein the processor 1301 is arranged to:

when it is determined that a balance of a first virtual public transit card associated with a prepaid public transit card is smaller than a first preset balance threshold, perform a remittance to a bank account associated with transportation card management equipment corresponding to the first virtual public transit card on the basis of the prepaid public transit card when a balance of the prepaid public transit card is larger than a second preset balance threshold, wherein the prepaid public transit card is associated with at least one virtual public transit card; and

send a second charging request to the transportation card management equipment corresponding to the first virtual public transit card, the second charging request including a remittance voucher and an identifier of the first virtual public transit card.

In an example, the processor 1301 may further be arranged to:

when a first charging request containing the identifier of the first virtual public transit card is received from a terminal, determine that the balance of the first virtual public transit card associated with the prepaid public transit card is smaller than the first preset balance threshold;

or,

acquire a balance of each virtual public transit card according to historical charging data of a user, and determine the first virtual public transit card of which the balance is smaller than the first preset balance threshold.

In an example, the processor 1301 may further be arranged to:

when it is determined that the balance of the prepaid public transit card is smaller than the second preset balance threshold, send a charging prompt to the terminal, wherein the charging prompt is arranged to prompt the user to charge the prepaid public transit card; or,

when it is determined that the balance of the prepaid public transit card is smaller than the second preset balance threshold, deduct a preset charging amount from a financial account of the user associated with the prepaid public transit card, and charge the prepaid public transit card by virtue of the preset charging amount.

In an example, the processor 1301 may further be arranged to:

acquire a latest usage time of each virtual public transit card;

determine, as a second virtual public transit card, a virtual public transit card of which the latest usage time is earlier than a preset time threshold; and

send a drawback instruction to transportation card management equipment corresponding to the second virtual public transit card, wherein the drawback instruction is arranged to cause the transportation card management equipment corresponding to the second virtual public transit card to draw a balance of the second virtual public transit card back to the prepaid public transit card.

With respect to the devices in the above examples, the specific manners for performing operations for individual modules therein have been described in detail in the examples regarding the methods, which will not be elaborated herein.

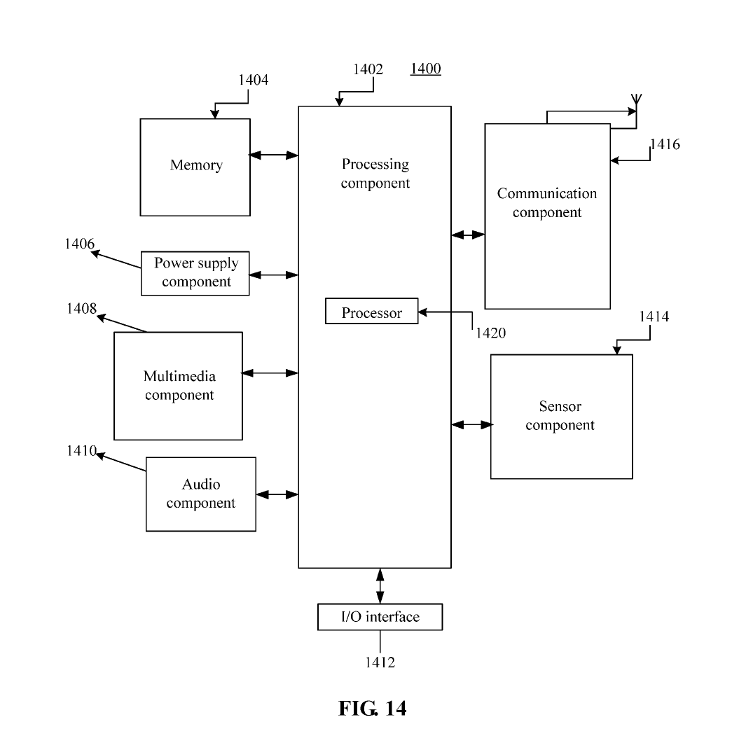

FIG. 14 is a block diagram of a public transit payment device, according to an example. For example, the public transit payment device 1400 may be equipment such as an intelligent mobile terminal, a tablet computer and wearable equipment.

Referring to FIG. 14, the public transit payment device 1400 may include one or more of the following components: a processing component 1402, a memory 1404, a power supply component 1406, a multimedia component 1408, an audio component 1410, an Input/Output (I/O) interface 1412, a sensor component 1414, and a communication component 1416.

The processing component 1402 typically controls overall operations of the public transit payment device 1400, such as the operations associated with display, telephone calls, data communications, camera operations, and recording operations. The processing component 1402 may include one or more processors 1420 to execute instructions to perform all or part of the steps in the abovementioned method. Moreover, the processing component 1402 may include one or more modules which facilitate interaction between the processing component 1402 and the other components. For instance, the processing component 1402 may include a multimedia module to facilitate interaction between the multimedia component 1408 and the processing component 1402.

The memory 1404 is arranged to store various types of data to support the operation of the public transit payment device 1400. Examples of such data include instructions for any application programs or methods operated on the public transit payment device 1400, contact data, phonebook data, messages, pictures, video, etc. The memory 1404 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power supply component 1406 provides power for various components of the public transit payment device 1400. The power supply component 1406 may include a power management system, one or more power supplies, and other components associated with the generation, management and distribution of power for the public transit payment device 1400.

The multimedia component 1408 includes a screen providing an output interface between the public transit payment device 1400 and a user. In some examples, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also detect a duration and pressure associated with the touch or swipe action. In some examples, the multimedia component 1408 includes a front camera and/or a rear camera. The front camera and/or the rear camera may receive external multimedia data when the public transit payment device 1400 is in an operation mode, such as a photographing mode or a video mode. Each of the front camera and the rear camera may be a fixed optical lens system or have focusing and optical zooming capabilities.

The audio component 1410 is arranged to output and/or input an audio signal. For example, the audio component 1410 includes a Microphone (MIC), and the MIC is arranged to receive an external audio signal when the public transit payment device 1400 is in the operation mode, such as a call mode, a recording mode and a voice recognition mode. The received audio signal may be further stored in the memory 1404 or sent through the communication component 1416. In some examples, the audio component 1410 further includes a speaker arranged to output the audio signal.

The I/O interface 1412 provides an interface between the processing component 1402 and a peripheral interface module, and the peripheral interface module may be a keyboard, a click wheel, a button and the like. The button may include, but not limited to: a home button, a volume button, a starting button and a locking button.

The sensor component 1414 includes one or more sensors arranged to provide status assessment in various aspects for the public transit payment device 1400. For instance, the sensor component 1414 may detect an on/off status of the public transit payment device 1400 and relative positioning of components, such as a display and small keyboard of the public transit payment device 1400, and the sensor component 1414 may further detect a change in a position of the public transit payment device 1400 or a component of the public transit payment device 1400, presence or absence of contact between the user and the public transit payment device 1400, orientation or acceleration/deceleration of the public transit payment device 1400 and a change in temperature of the public transit payment device 1400. The sensor component 1414 may include a proximity sensor arranged to detect presence of an object nearby without any physical contact. The sensor component 1414 may also include a light sensor, such as a Complementary Metal Oxide Semiconductor (CMOS) or Charge Coupled Device (CCD) image sensor, arranged for use in an imaging application. In some examples, the sensor component 1414 may also include an acceleration sensor, a gyroscope sensor, a magnetic sensor, a pressure sensor or a temperature sensor.

The communication component 1416 is arranged to facilitate wired or wireless communication between the public transit payment device 1400 and other equipment. The public transit payment device 1400 may access a communication-standard-based wireless network, such as a Wireless Fidelity (WiFi) network, a 2nd-Generation (2G) or 3rd-Generation (3G) network or a combination thereof. In an example, the communication component 1416 receives a broadcast signal or broadcast associated information from an external broadcast management system through a broadcast channel. In an example, the communication component 1416 further includes an NFC module to facilitate short-range communication. For example, the NFC module may be implemented on the basis of a Radio Frequency Identification (RFID) technology, an Infrared Data Association (IrDA) technology, an Ultra-WideBand (UWB) technology, a Bluetooth (BT) technology and another technology.

In an example, the public transit payment device 1400 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is arranged to execute the abovementioned method.

In an example, there is also provided a non-transitory computer-readable storage medium including an instruction, such as the memory 1404 including an instruction, and the instruction may be executed by the processor 1420 of the public transit payment device 1400 to implement the abovementioned method. For example, the non-transitory computer-readable storage medium may be a ROM, a Random Access Memory (RAM), a Compact Disc Read-Only Memory (CD-ROM), a magnetic tape, a floppy disc, optical data storage equipment and the like.

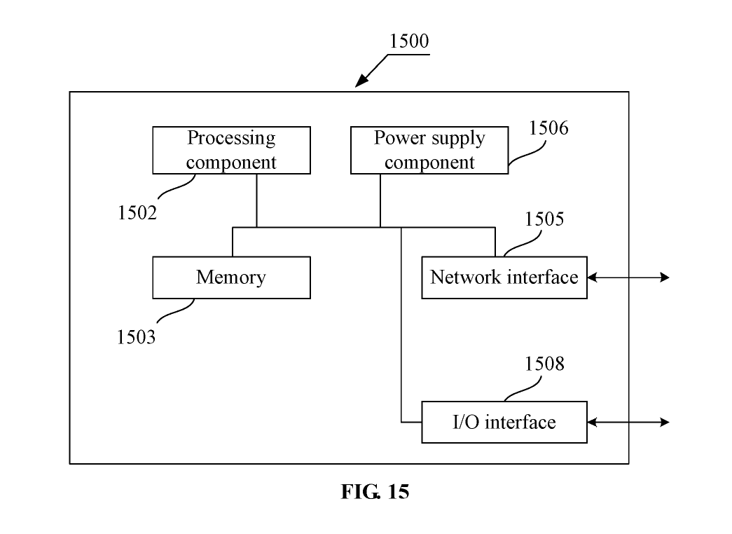

FIG. 15 is a block diagram of a public transit payment device, according to an example. For example, the public transit payment device 1500 may be provided as a server. The public transit payment device 1500 includes a processing component 1502, further including one or more processors, and a memory resource represented by a memory 1503 arranged to store instructions executable by the processing component 1502, such as application programs. The application programs stored in the memory 1503 may include one or more than one module of which each corresponds to a set of instructions. In addition, the processing component 1502 is arranged to execute the instructions, so as to execute the abovementioned method.

The public transit payment device 1500 may further include a power supply component 1506 arranged to execute power management of the public transit payment device 1500, a wired or wireless network interface 1505 arranged to connect the public transit payment device 1500 to a network, and an I/O interface 1508. The public transit payment device 1500 may be operated on the basis of an operating system stored in the memory 1503, such as Windows Server™, Mac OS X™, Unix™, Linux™ or FreeBSD™.

According to one aspect of the examples of the present disclosure, there is provided a public transit payment method, which is applied to a terminal and includes:

when it is detected that a balance of a first virtual public transit card associated with a prepaid public transit card is smaller than a first preset balance threshold, a first charging request containing an identifier of the first virtual public transit card is sent to a server, wherein the prepaid public transit card may be associated with at least one virtual public transit card;

a charging response for the first virtual public transit card is received; and

a public transit payment operation is performed by virtue of the first virtual public transit card.

According to another aspect of the examples of the present disclosure, there is provided a public transit payment method, which is applied to a server and includes:

when it is determined that a balance of a first virtual public transit card associated with a prepaid public transit card is smaller than a first preset balance threshold, a remittance to a bank account associated with transportation card management equipment corresponding to the first virtual public transit card is performed on the basis of the prepaid public transit card when a balance of the prepaid public transit card is larger than a second preset balance threshold, wherein the prepaid public transit card may be associated with at least one virtual public transit card; and

a second charging request is sent to the transportation card management equipment corresponding to the first virtual public transit card, the second charging request including a remittance voucher and an identifier of the first virtual public transit card.

According to an additional aspect of the examples of the present disclosure, there is provided a public transit payment device, which includes:

a processor; and

a memory arranged to store instructions executable by the processor,

wherein the processor may be arranged to:

when it is detected that a balance of a first virtual public transit card associated with a prepaid public transit card is smaller than a first preset balance threshold, send a first charging request containing an identifier of the first virtual public transit card to a server, wherein the prepaid public transit card may be associated with at least one virtual public transit card;

receive a charging response for the first virtual public transit card; and

perform a public transit payment operation by virtue of the first virtual public transit card.

According to an additional further aspect of the examples of the present disclosure, there is provided a public transit payment device, which includes:

a processor; and

a memory arranged to store instructions executable by the processor,

wherein the processor may be arranged to:

when it is determined that a balance of a first virtual public transit card associated with a prepaid public transit card is smaller than a first preset balance threshold, perform a remittance to a bank account associated with transportation card management equipment corresponding to the first virtual public transit card on the basis of the prepaid public transit card when a balance of the prepaid public transit card is larger than a second preset balance threshold, wherein the prepaid public transit card may be associated with at least one virtual public transit card; and

send a second charging request to the transportation card management equipment corresponding to the first virtual public transit card, the second charging request including a remittance voucher and an identifier of the first virtual public transit card.

According to examples of the present disclosure, there is provided a non-transitory computer-readable storage medium having stored thereon computer instructions executed by a processor to implement the steps of the method of the first aspect.

According to examples of the present disclosure, there is provided a non-transitory computer-readable storage medium having stored thereon computer instructions executed by a processor to implement the steps of the method of the first aspect.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “circuit,” “sub-circuit,” “circuitry,” “sub-circuitry,”“unit,” or “sub-unit” may include memory (shared, dedicated, or group) that stores code or instructions that can be executed by one or more processors.

Other examples of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A public transit payment method, applied to a terminal, comprising:
when it is detected that a balance of a first virtual public transit card associated with a prepaid public transit card is smaller than a first preset balance threshold, sending a first charging request containing an identifier of the first virtual public transit card to a server, wherein the prepaid public transit card is associated with at least one virtual public transit card;
receiving a charging response for the first virtual public transit card; and
performing a public transit payment operation by using the first virtual public transit card.

2. The method of claim 1, further comprising:
acquiring a current position; and
activating the first virtual public transit card, the first virtual public transit card being associated with the current position.

3. The method of claim 1, further comprising:
acquiring preconfigured information of a unified card face; and
displaying the prepaid public transit card according to the information of the unified card face, wherein more than one virtual public transit cards associated with the prepaid public transit card are locally stored.

4. The method of claim 1, wherein the first preset balance threshold comprises: a maximum single public transit consumption value of a target city or a double of the maximum single public transit consumption value of the target city.

5. The method of claim 1, further comprising:
when it is determined that a balance of the prepaid public transit card is smaller than a second preset balance threshold, charging the prepaid public transit card.

6. A public transit payment device, comprising:
a processor; and
a memory arranged to store instructions executable by the processor,
wherein the processor is arranged to:
when it is detected that a balance of a first virtual public transit card associated with a prepaid public transit card is smaller than a first preset balance threshold, send a first charging request containing an identifier of the first virtual public transit card to a server, wherein the prepaid public transit card is associated with at least one virtual public transit card;
receive a charging response for the first virtual public transit card; and
perform a public transit payment operation by using the first virtual public transit card.

7. The device of claim 6, wherein the processor is further arranged to:
acquire a current position; and
activate the first virtual public transit card, the first virtual public transit card being associated with the current position.

8. The device of claim 6, wherein the processor is further arranged to:
acquire preconfigured information of a unified card face; and
display the prepaid public transit card according to the information of the unified card face, wherein more than one virtual public transit cards associated with the prepaid public transit card are locally stored.

9. The device of claim 6, wherein the first preset balance threshold comprises: a maximum single public transit consumption value of a target city or a double of the maximum single public transit consumption value of the target city.

10. The device of claim 6, wherein the processor is further arranged to:
when it is determined that a balance of the prepaid public transit card is smaller than a second preset balance threshold, charge the prepaid public transit card.

11. A public transit payment device, comprising:
a processor; and
a memory arranged to store instructions executable by the processor,
wherein the processor is arranged to:
when it is determined that a balance of a first virtual public transit card associated with a prepaid public transit card is smaller than a first preset balance threshold, perform a remittance to a bank account associated with transportation card management equipment corresponding to the first virtual public transit card associated with the prepaid public transit card when a balance of the prepaid public transit card is larger than a second preset balance threshold, wherein the prepaid public transit card is associated with at least one virtual public transit card; and
send a second charging request to the transportation card management equipment corresponding to the first virtual public transit card, the second charging request comprising a remittance voucher and an identifier of the first virtual public transit card.

12. The device of claim 11, wherein, in order to determine that the balance of the first virtual public transit card associated with the prepaid public transit card is smaller than the first preset balance threshold, the processor is arranged to:
when a first charging request containing the identifier of the first virtual public transit card is received from a terminal, determine that the balance of the first virtual public transit card associated with the prepaid public transit card is smaller than the first preset balance threshold;
or,
acquire a balance of each virtual public transit card according to historical charging data, and determine the first virtual public transit card of which the balance is smaller than the first preset balance threshold.

13. The device of claim 11, wherein the processor is further arranged to:
when it is determined that the balance of the prepaid public transit card is smaller than the second preset balance threshold, send a charging prompt to a terminal, wherein the charging prompt is arranged to charge the prepaid public transit card; or,
when it is determined that the balance of the prepaid public transit card is smaller than the second preset balance threshold, deduct a preset charging amount from a financial account associated with the prepaid public transit card, and charge the prepaid public transit card by using the preset charging amount.

14. The device of claim 11, wherein the processor is further arranged to:
acquire a latest usage time of each virtual public transit card;
determine, as a second virtual public transit card, a virtual public transit card of which the latest usage time is earlier than a preset time threshold; and
send a drawback instruction to transportation card management equipment corresponding to the second virtual public transit card, wherein the drawback instruction is arranged to cause the transportation card management equipment corresponding to the second virtual public transit card to draw a balance of the second virtual public transit card back to the prepaid public transit card.
